(19) United States
(12) Patent Application Publication
(10) Pub. No.: US 2025/0166369 A1
(43) Pub. Date: May 22, 2025

(54) ELECTRONIC DEVICE FOR IMAGE PROCESSING AND CONTROL METHOD THEREFOR

(71) Applicant: SAMSUNG ELECTRONICS CO., LTD., Suwon-si (KR)

(72) Inventors: Chun ZHAO, Suwon-si (KR); Seonseok KIM, Suwon-si (KR); Jonghwan KIM, Suwon-si (KR); Guiwon SEO, Suwon-si (KR)

(73) Assignee: SAMSUNG ELECTRONICS CO., LTD., Suwon-si (KR)

(21) Appl. No.: 19/025,126

(22) Filed: Jan. 16, 2025

Related U.S. Application Data
(63) Continuation of application No. PCT/KR2023/008464, filed on Jun. 19, 2023.

(30) Foreign Application Priority Data
Aug. 18, 2022 (KR) 10-2022-0103551

(51) Int. Cl. G06V 10/70; G06V 10/82

(52) U.S. Cl. CPC G06V 10/87; G06V 10/82

(57) ABSTRACT

An electronic device is configured to identify a scene type of a first frame included in a content by inputting the first frame into the first neural network model, transmit the scene type of the first frame to a server, receive, from the server in response to the transmitted scene type of the first frame, a second neural network model and a first parameter corresponding to the scene type of the first frame, replace the first neural network model with the second neural network model, and perform image processing on the first frame based on the first parameter, and in which the second neural network model is one of a plurality of second neural network models respectively corresponding to a plurality of scene types that can be output from the first neural network model.

### CROSS-REFERENCE TO RELATED APPLICATIONS

This application is a continuation of PCT International Application No. PCT/KR2023/008464, which was filed on Jun. 19, 2023, and claims priority to Korean Patent Application No. 10-2022-0103551, filed on Aug. 18, 2022 in the Korean Intellectual Property Office, the disclosures of each of which are incorporated by reference herein their entirety.

### BACKGROUND

### 1. Field

The disclosure relates to an electronic device and a control method therefor, and more particularly, to an electronic device that performs image processing, and a control method therefor.

### 2. Description of Related Art

Spurred by the development of electronic technologies, various types of electronic devices are being developed. For example, user convenience is improving as electronic devices using neural network models in an image processing process are being utilized.

However, as neural network models of high performance have been developed, there are problems that hardware resources of the electronic devices such as processing capacity or storage capacity are insufficient. Furthermore, pre-processing is complex, and upgrade hardware and software is not easy.

### SUMMARY

According to an aspect of the disclosure, an electronic device includes: memory storing one or more instructions and a first neural network model; a communication interface; and at least one processor operatively coupled with the memory and the communication interface, the one or more instructions, when executed by the at least one processor, causes the electronic device to: identify a scene type of a first frame included in a content by inputting the first frame into the first neural network model, control the communication interface to transmit the scene type of the first frame to a server, receive, from the server through the communication interface in response to the transmitted scene type of the first frame, a second neural network model and a first parameter corresponding to the scene type of the first frame, replace the first neural network model with the second neural network model, and perform image processing on the first frame based on the first parameter, and wherein the second neural network model is one of a plurality of second neural network models respectively corresponding to a plurality of scene types that can be output from the first neural network model.

According to an aspect of the disclosure, the one or more instructions, when executed by the at least one processor, further cause the electronic device to: identify a scene type of a second frame after the first frame by inputting the second frame into the second neural network model, control the communication interface to transmit the scene type of the second frame to the server, receive, from the server through the communication interface in response to the transmitted scene type of the second frame, a third neural network model and a second parameter corresponding to the scene type of the second frame from the server through the communication interface, replace the second neural network model with the third neural network model, and perform image processing on the second frame based on the second parameter, and wherein the third neural network model is one of a plurality of third neural network models respectively corresponding to a plurality of scene types that can be output from the second neural network model.

According to an aspect of the disclosure, the one or more instructions, when executed by the at least one processor, further cause the electronic device to: obtain a plurality of feature points by pre-processing the second frame, and based on the second frame corresponding to the scene type of the first frame on the basis of the plurality of feature points, input the second frame into the second neural network model to identify the scene type of the second frame.

According to an aspect of the disclosure, the memory further stores a basic neural network model, and the one or more instructions, when executed by the at least one processor, further cause the electronic device to: based on the second frame not corresponding to the scene type of the first frame on the basis of the plurality of feature points, identify the scene type of the second frame by inputting the second frame into the basic neural network model, and wherein the basic neural network model is a neural network model of a highest hierarchy among a plurality of neural network models stored in a hierarchical tree structure in the server.

According to an aspect of the disclosure, the electronic device further includes a user interface, the one or more instructions, when executed by the at least one processor, further cause the electronic device to: receive a user input regarding an operation mode through the user interface, and based on determining the operation mode is a first mode, update the second neural network model to the third neural network model, and based on determining the operation mode is a second mode, not update the second neural network model to the third neural network model.

According to an aspect of the disclosure, the memory further stores a plurality of image processing engines, and the one or more instructions, when executed by the at least one processor, further cause the electronic device to: perform image processing on the frames included in the content by using one or more image processing engines from the plurality of image processing engines corresponding to the scene types of the frames included in the content.

According to an aspect of the disclosure, the one or more instructions, when executed by the at least one processor, further causes the electronic device to: update the scene types of the frames included in the content by a predetermined interval.

According to an aspect of the disclosure, the memory further stores a basic neural network model, and the one or more instructions, when executed by the at least one processor, further cause the electronic device to: based on a number of times of identifying scene types through one neural network model being greater than or equal to a predetermined number of times, identify scene types by using the basic neural network model, and the basic neural network model is a neural network model of a highest hierarchy among a plurality of neural network models stored in a hierarchical tree structure in the server.

According to an aspect of the disclosure, the electronic device further includes a display, and he one or more instructions, when executed by the at least one processor, further causes the electronic device to: control the display to display the first frame that went through image processing.

According to an aspect of the disclosure, a control method for an electronic device includes identifying a scene type of a first frame included in a content by inputting the first frame into the first neural network model; transmitting the scene type of the first frame to a server; receiving, from the server in response to the transmitted scene type of the first frame, a second neural network model and a first parameter corresponding to the scene type of the first frame; and replacing the first neural network model with the second neural network model, and performing image processing on the first frame based on the first parameter, wherein the second neural network model is one of a plurality of second neural network models respectively corresponding to a plurality of scene types that can be output from the first neural network model.

According to an aspect of the disclosure, the method further includes identifying a scene type of a second frame after the first frame by inputting the second frame into the second neural network model; transmitting the scene type of the second frame to the server; receiving, from the server in response to transmitting the scene type of the second frame, a third neural network model and a second parameter corresponding to the scene type of the second frame; and replacing the second neural network model with the third neural network model, and performing image processing on the second frame based on the second parameter, wherein the third neural network model is one of a plurality of third neural network models respectively corresponding to a plurality of scene types that can be output from the second neural network model.

According to an aspect of the disclosure, the identifying the scene type of the second frame includes: obtaining a plurality of feature points by pre-processing the second frame; and based on the second frame corresponding to the scene type of the first frame on the basis of the plurality of feature points, inputting the second frame into the second neural network model to identify the scene type of the second frame.

According to an aspect of the disclosure, the identifying the scene type of the second frame includes: based on the second frame not corresponding to the scene type of the first frame on the basis of the plurality of feature points, identifying the scene type of the second frame by inputting the second frame into the basic neural network model, and the basic neural network model is a neural network model of the highest hierarchy among a plurality of neural network models stored in a hierarchical tree structure in the server.

According to an aspect of the disclosure, the method further includes receiving a user input regarding an operation mode, the performing image processing on the second frame includes: based on determining the operation mode is a first mode, updating the second neural network model to the third neural network model, and based on determining the operation mode is a second mode, not updating the second neural network model to the third neural network model.

According to an aspect of the disclosure, the performing image processing on the first frame includes: performing image processing on the frames included in the content by using one or more image processing engines among a plurality of image processing engines corresponding to the scene types of the frames included in the content.

According to an aspect of the disclosure, a non-transitory computer readable medium, having instructions stored therein, which when executed by a processor in an electronic device, cause the electronic device to perform a method including: identifying a scene type of a first frame included in a content by inputting the first frame into the first neural network model; transmitting the scene type of the first frame to a server; receiving, from the server in response to the transmitted scene type of the first frame, a second neural network model and a first parameter corresponding to the scene type of the first frame; and replacing the first neural network model with the second neural network model, and performing image processing on the first frame based on the first parameter, wherein the second neural network model is one of a plurality of second neural network models respectively corresponding to a plurality of scene types that can be output from the first neural network model.

According to an aspect of the disclosure, the method further includes identifying a scene type of a second frame after the first frame by inputting the second frame into the second neural network model; transmitting the scene type of the second frame to the server; receiving, from the server in response to transmitting the scene type of the second frame, a third neural network model and a second parameter corresponding to the scene type of the second frame; and replacing the second neural network model with the third neural network model, and performing image processing on the second frame based on the second parameter, wherein the third neural network model is one of a plurality of third neural network models respectively corresponding to a plurality of scene types that can be output from the second neural network model.

According to an aspect of the disclosure, the identifying the scene type of the second frame includes: obtaining a plurality of feature points by pre-processing the second frame; and based on the second frame corresponding to the scene type of the first frame on the basis of the plurality of feature points, inputting the second frame into the second neural network model to identify the scene type of the second frame.

According to an aspect of the disclosure, the identifying the scene type of the second frame includes: based on the second frame not corresponding to the scene type of the first frame on the basis of the plurality of feature points, identifying the scene type of the second frame by inputting the second frame into the basic neural network model, and the basic neural network model is a neural network model of the highest hierarchy among a plurality of neural network models stored in a hierarchical tree structure in the server.

According to an aspect of the disclosure, the method further includes: receiving a user input regarding an operation mode, wherein the performing image processing on the second frame includes: based on determining the operation mode is a first mode, updating the second neural network model to the third neural network model, and based on determining the operation mode is a second mode, not updating the second neural network model to the third neural network model.

### BRIEF DESCRIPTION OF DRAWINGS

FIG. 1A and FIG. 1B are diagrams for illustrating a method of classifying images;

FIG. 2 is a block diagram illustrating a configuration of an electronic system according to one or more embodiments of the disclosure;

FIG. 3 is a block diagram illustrating a configuration of an electronic device according to one or more embodiments of the disclosure;

FIG. 4 is a block diagram illustrating a detailed configuration of an electronic device according to one or more embodiments of the disclosure;

FIG. 5 is a block diagram illustrating a configuration of a server according to one or more embodiments of the disclosure;

FIG. 6 is a diagram for illustrating operations of an electronic device and a server according to one or more embodiments of the disclosure;

FIG. 7 is a diagram for illustrating a plurality of neural network models constituted in a hierarchical tree structure according to one or more embodiments of the disclosure;

FIG. 8 is a diagram for illustrating in more detail a plurality of neural network models constituted in a hierarchical tree structure according to one or more embodiments of the disclosure;

FIG. 9 is a diagram for illustrating information on a plurality of parameters according to one or more embodiments of the disclosure;

FIG. 10 is a diagram for illustrating an operation after classification of scene types according to one or more embodiments of the disclosure;

FIG. 11 is a flow chart for illustrating update of scene types according to one or more embodiments of the disclosure; and

FIG. 12 is a flow chart for illustrating a control method for an electronic device according to one or more embodiments of the disclosure.

### DETAILED DESCRIPTION

The purpose of the disclosure is in providing an electronic device that performs image processing of high performance even when hardware of a low specification is used, and a control method therefor. In one or more examples, hardware of a low specification may refer to a device having a processing capacity that is below a processing threshold or storage capacity that is below a storage threshold.

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g., elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second” and the like used in this specification may be used to describe various elements regardless of any order and/or degree of importance. Also, such expressions are used only to distinguish one element from another element, and are not intended to limit the elements.

Also, singular expressions include plural expressions, unless defined obviously differently in the context. In addition, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in this specification, the term “user” may refer to a person who uses an electronic device or a device using an electronic device (e.g., an artificial intelligence electronic device).

Hereinafter, various embodiments of the disclosure will be described in more detail with reference to the accompanying drawings.

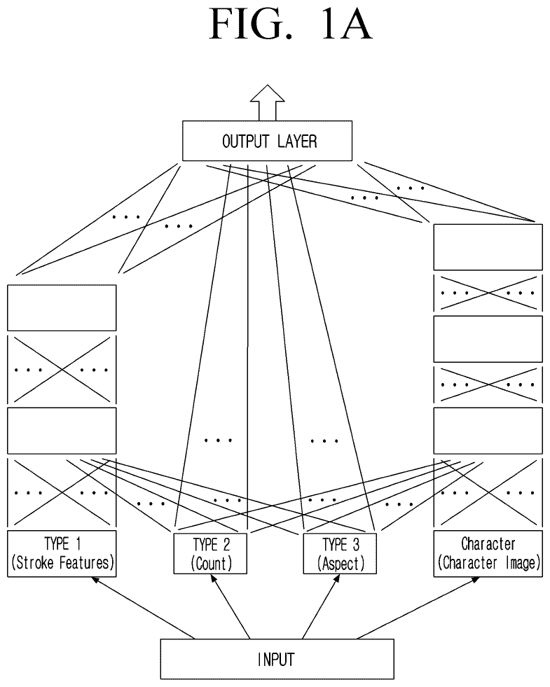

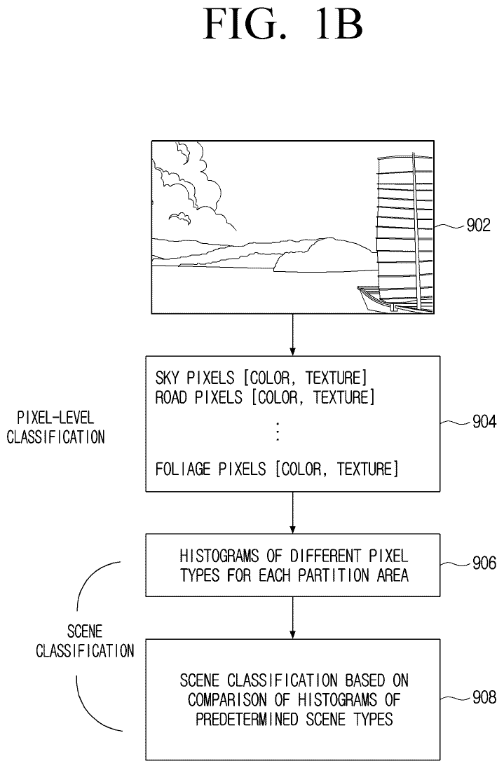

FIG. 1A and FIG. 1B are diagrams for illustrating a method of classifying images.

There are various methods of classifying scene types of an image or a content.

For example, as illustrated in FIG. 1A, scene types of an image or a content may be classified by using a single neural network model. However, there is a problem that hardware consumption increases as scene types become more diverse. For example, as scenes are becoming more complex, the processing capacity required to identify these scenes increases.

Alternatively, as illustrated in FIG. 1B, local areas may be defined by moving motions, and scene categories of an image may be classified based on pixel levels of local areas and local histograms. In this case, the accuracy is high, but there is a problem that pre-processing is difficult. In one or more examples, pre-processing may refer to processing of an image or frame prior to inputting the image or frame into a neural network to identify a scene.

Also, in both cases, classifiers, network coefficients, etc. are fixed, and thus upgrade may be difficult.

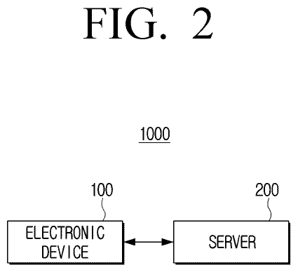

FIG. 2 is a block diagram illustrating an example configuration of an electronic system 1000 according to one or more embodiments of the disclosure. As illustrated in FIG. 2, the electronic system 1000 includes an electronic device 100 and a server 200.

According to one or more embodiments, the electronic device 100 is a device that identifies a scene type, and performs image processing corresponding to the scene type. In one or more examples, the electronic device 100 may be implemented as a computer main body, a set top box (STB), an AI speaker, a TV, a desktop PC, a laptop, a smartphone, a tablet PC, smart glasses, a smart watch, etc. However, the disclosure is not limited thereto, and the electronic device 100 can be any device if it is a device that can identify a scene type, and perform image processing corresponding to the scene type.

The electronic device 100 may receive a neural network model from the server 200, and identify a scene type by using the neural network model. The electronic device 100 may transmit the scene type to the server 200, and receive a parameter corresponding to the scene type from the server 200, and perform image processing on the content by using the parameter.

The server 200 may store a plurality of neural network models constituted in a hierarchical tree structure and a plurality of parameters, and provide one of the plurality of neural network models to the electronic device 100. When a scene type is received from the electronic device 100, the server 200 may provide a parameter corresponding to the scene type to the electronic device 100. Also, the server 200 may provide a neural network model corresponding to the scene type to the electronic device 100.

The server 200 may update the plurality of neural network models based on new sample data. Each coefficient of the plurality of neural network models may vary according to the update, and the tree structure may also be changed.

In one or more examples, the electronic device 100 and the server 200 may communicate with each other over one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

Although FIG. 2 illustrates one server 200, the embodiments are not limited to this configuration, where the electronic device may communicate with a plurality of servers. Furthermore, the servers may operate in a cloud computing environment that provides computation, software, data access, storage, etc. services that do not require end-user (e.g. the knowledge of a physical location and configuration of system(s) and/or device(s).

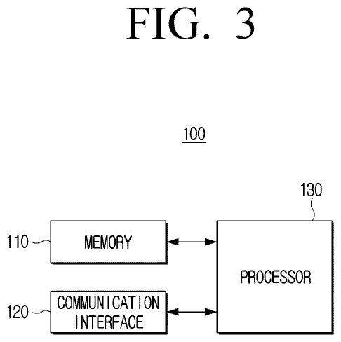

FIG. 3 is a block diagram illustrating a configuration of the electronic device 100 according to one or more embodiments of the disclosure.

According to FIG. 3, the electronic device 100 includes memory 110, a communication interface 120, and a processor 130.

The memory 110 may refer to hardware that stores information such as data, etc. in an electric or a magnetic form such that the processor 130, etc. can access the information. For this, the memory 110 may be implemented as at least one hardware among non-volatile memory, volatile memory, flash memory, a hard disc drive (HDD) or a solid state drive (SSD), RAM, ROM, etc.

In the memory 110, at least one instruction necessary for operations of the electronic device 100 or the processor 130 may be stored. Here, an instruction is a code unit instructing the operations of the electronic device 100 or the processor 130, and it may have been drafted in a machine language which is a language that can be understood by a computer. Alternatively, in the memory 110, a plurality of instructions performing specific tasks of the electronic device 100 or the processor 130 may be stored as an instruction set.

In the memory 110, data which is information in bit or byte units that can indicate characters, numbers, images, etc. may be stored. For example, in the memory 110, a neural network model and an image processing engine, etc. may be stored.

The memory 110 may be accessed by the processor 130, and reading/recording/correction/deletion/update, etc. for an instruction, an instruction set, or data may be performed by the processor 130.

The communication interface 120 is a component performing communication with various types of external devices according to various types of communication methods. For example, the electronic device 100 may perform communication with the server 200 or a user terminal through the communication interface 120.

The communication interface 120 may include a Wi-Fi module, a Bluetooth module, an infrared communication module, and a wireless communication module, etc. Here, each communication module may be implemented in a form of at least one hardware chip.

A Wi-Fi module and a Bluetooth module perform communication by a Wi-Fi method and a Bluetooth method, respectively. In the case of using a Wi-Fi module or a Bluetooth module, various types of connection information such as an SSID and a session key is transmitted and received first, and connection of communication is performed by using the information, and various types of information can be transmitted and received thereafter. An infrared communication module performs communication according to an infrared Data Association (IrDA) technology of transmitting data to a near field wirelessly by using infrared rays between visible rays and millimeter waves.

A wireless communication module may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

Alternatively, the communication interface 120 may include a wired communication interface such as an HDMI, a DP, a Thunderbolt, a USB, an RGB, a D-SUB, a DVI, etc.

Other than the above, the communication interface 120 may include at least one of a local area network (LAN) module, an Ethernet module, or a wired communication module that performs communication by using a pair cable, a coaxial cable, or an optical fiber cable, etc.

The processor 130 controls the overall operations of the electronic device 100. Specifically, the processor 130 may be connected with each component of the electronic device 100, and control the overall operations of the electronic device 100. For example, the processor 130 may be connected with components such as the memory 110, the communication interface 120, a display, etc., and control the operations of the electronic device 100.

According to one or more embodiments, the processor 130 may be implemented as a digital signal processor (DSP), a microprocessor, and a time controller (TCON). However, the disclosure is not limited thereto, and the processor 130 may include one or more of a central processing unit (CPU), a micro controller unit (MCU), a micro processing unit (MPU), a controller, an application processor (AP) or a communication processor (CP), and an ARM processor, or may be defined by the terms. Also, the processor 130 may be implemented as a system on chip (SoC) having a processing algorithm stored therein or large scale integration (LSI), or in the form of a field programmable gate array (FPGA).

The processor 130 may be implemented as one processor or a plurality of processors. However, hereinafter, operations of the electronic device 100 will be explained with the expression ‘the processor 130,’ for the convenience of explanation.

In one or more examples, the processor 130 may input a first frame included in a content into a first neural network model stored in the memory 110, and identify the scene type of the first frame. For example, the processor 130 may input the first frame included in a content into the first neural network model, and identify that the scene type of the first frame is a movie type. In one or more examples, the first neural network model may be a neural network model that was received from the server 200 based on the scene type of a previous frame of the first frame. Alternatively, the first neural network model may be a basic neural network model which is a neural network model of the highest hierarchy among a plurality of neural network models stored in a hierarchical tree structure in the server 200.

The processor 130 may control the communication interface 120 to transmit the scene type of the first frame to the server 200, and receive a second neural network model and a first parameter corresponding to the scene type of the first frame from the server 200 through the communication interface 120. In one or more examples, the second neural network model may be one of a plurality of second neural network models respectively corresponding to a plurality of scene types that can be output from the first neural network model.

For example, the plurality of scene types that can be output from the first neural network model may be a movie type, a sport type, a game type, and a documentary type, and the plurality of second neural network models may include a second neural network model corresponding to the movie type, a second neural network model corresponding to the sport type, a second neural network model corresponding to the game type, and a second neural network model corresponding to the documentary type. The processor 130 may control the communication interface 120 to transmit the movie type which is the scene type of the first frame to the server 200, and receive the second neural network model corresponding to the movie type and a first parameter corresponding to the movie type from the server 200 through the communication interface 120.

The processor 130 may update the first neural network model to the second neural network model, and perform image processing on the first frame based on the first parameter. In one or more examples, the updating of the first neural network model to the second neural network model may refer to replacing the first neural network model with the second neural network model. For example, when the electronic device 100 receives the second neural network model, the first neural network model may be deleted from the memory of the electronic device 100 while the second neural network model is stored in the memory. In one or more examples, updating the first neural network model to the second neural network model may refer to adjusting one or more layers of the first neural network model based on one or more layers of the second neural network model. Alternatively, if the first neural network model is not the basic neural network model, the processor 130 may update the first neural network model to the second neural network model, and if the first neural network model is the basic neural network model, the processor 130 may additionally store the second neural network model.

The processor 130 may input a second frame after the first frame into the second neural network model and identify the scene type of the second frame. For example, the processor 130 may input the second frame into the second neural network model and identify that the scene type of the second frame is a black-and-white movie type.

The processor 130 may control the communication interface 120 to transmit the scene type of the second frame to the server 200, and receive a third neural network model and a second parameter corresponding to the scene type of the second frame from the server 200 through the communication interface 120. In one or more examples, the third neural network model may be one of a plurality of third neural network models respectively corresponding to a plurality of scene types that can be output from the second neural network model.

The processor 130 may update the second neural network model to the third neural network model, and perform image processing on the second frame based on the second parameter. Accordingly, the neural network models stored in the memory 110 may be maintained as two at the maximum, and thus, the capacity of the memory 110 is advantageously reduced, and at the same time, scene types can be identified by using various neural network models.

Furthermore, as one of the plurality of neural network models implemented in a hierarchical tree structure is used in a stepwise manner, the processor 130 may identify scene types in more detail, and perform image processing by using parameters corresponding to the scene types identified in detail. In one or more examples, the hierarchical tree structure may be organized in accordance with scenes of varying complexity, where scenes of complexity form the root of the hierarchical tree structure and scenes of higher complexity form one or more nodes of the hierarchical tree structure.

The processor 130 may obtain a plurality of feature points by pre-processing the second frame, and in case the second frame corresponds to the scene type of the first frame on the basis of the plurality of feature points, the processor 130 may input the second frame into the second neural network model, and identify the scene type of the second frame. In one or more examples, the feature points may be one or more objects that are identified in the frame such as an object to identify a type of landscape (e.g., tree, river, building, car, etc.).

Alternatively, the memory 110 may further store a basic neural network model, and in case the second frame does not correspond to the scene type of the first frame on the basis of the plurality of feature points, the processor 130 may input the second frame into the basic neural network model and identify the scene type of the second frame. For example, if it is identified that the scene type was changed, the processor 130 may identify the scene type by using the basic neural network model.

The electronic device 100 may further include a user interface, and the processor 130 may receive a user input regarding an operation mode through the user interface, and if the operation mode is a first mode, the processor 130 may update the second neural network model to the third neural network model, and if the operation mode is a second mode, the processor 130 may not update the second neural network model to the third neural network model. Through such an operation, load of the electronic device 100 can be reduced.

The memory 110 may further store a plurality of image processing engines, and the processor 130 may perform image processing on the frames included in a content by using image processing engines corresponding to the scene types of the frames included in the content among the plurality of image processing engines. For example, the processor 130 may identify an image processing engine corresponding to the scene type of a frame included in a content among the plurality of image processing engines, and receive a parameter corresponding to the scene type from the server 200, and perform image processing of the frame by applying the parameter to the image processing engine. Through such an operation, the processor 130 can advantageously perform image processing optimized for a scene type.

The processor 130 may update the scene types of the frames included in a content by a predetermined interval. For example, the processor 130 may update the scene types of the frames included in a content every 600 seconds. For example, the processor 130 may sequentially identify the scene types of the frames included in a content, but time points of transmitting the scene types to the server 200 may be at a predetermined interval. However, the disclosure is not limited thereto, and the processor 130 may identify the scene types of the frames included in a content by a predetermined interval.

If the number of times of identifying scene types through one neural network model is greater than or equal to a predetermined number of times, the processor 130 may identify scene types by using the basic neural network model. Through such an operation, an operation of identifying scene types may be periodically initialized.

The electronic device 100 may further include a display, and the processor 130 may control the display to display the first frame that went through image processing.

Meanwhile, functions related to artificial intelligence according to the disclosure may be operated through the processor 130 and the memory 110.

The processor 130 may consist of one or a plurality of processors. In one or more examples, the one or plurality of processors may be generic-purpose processors such as a CPU, an AP, a DSP, etc., graphic-dedicated processors such as a GPU and a vision processing unit (VPU), or artificial intelligence-dedicated processors such as an NPU.

The one or plurality of processors perform control such that input data is processed according to pre-defined operation rules or an artificial intelligence model stored in the memory 110. Alternatively, in case the one or plurality of processors are artificial intelligence-dedicated processors, the artificial intelligence-dedicated processors may be designed as a hardware structure specified for processing of a specific artificial intelligence model. The predefined operation rules or the artificial intelligence model are characterized in that they are made through learning.

In one or more examples, being made through learning means that an artificial intelligence model is trained by using a plurality of training data by a learning algorithm, and predefined operation rules or an artificial intelligence model set to perform desired characteristics (or, purposes) are thereby made. Such learning may be performed in a device itself wherein artificial intelligence is performed according to the disclosure, or performed through a separate server and/or system. As examples of learning algorithms, there are supervised learning, unsupervised learning, semi-supervised learning, or reinforcement learning, but learning algorithms in the disclosure are not limited to the aforementioned examples.

According to one or more embodiments, an artificial intelligence model may consist of a plurality of neural network layers. Each of the plurality of neural network layers has a plurality of weight values, and performs a neural network operation through an operation result of the previous layer and an operation of the plurality of weight values. The plurality of weight values included by the plurality of neural network layers may be optimized by the learning result of the artificial intelligence model. For example, the plurality of weight values may be updated such that a loss value or a cost value obtained at the artificial intelligence model during a learning process is reduced or minimized.

An artificial neural network may include a deep neural network (DNN), and there are, for example, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial network (GAN), or deep Q-networks, etc., but the disclosure is not limited to the aforementioned examples.

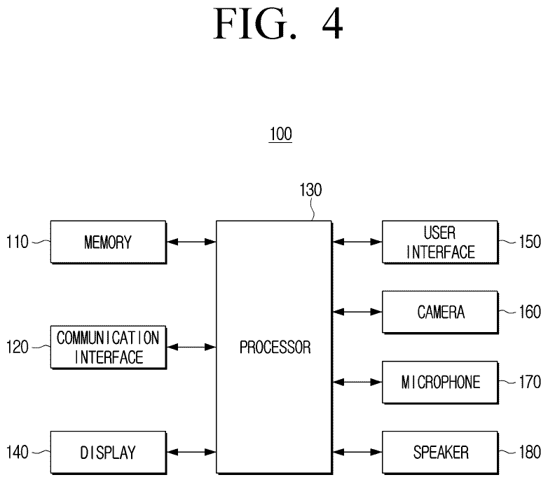

FIG. 4 is a block diagram illustrating a detailed configuration of the electronic device 100 according to one or more embodiments of the disclosure.

FIG. 4 is a block diagram illustrating a detailed configuration of the electronic device 100 according to one or more embodiments of the disclosure. The electronic device 100 may include memory 110, a communication interface 120, and a processor 130. Also, according to FIG. 4, the electronic device 100 may further include a display 140, a user interface 150, a camera 160, a microphone 170, and a speaker 180. Among the components illustrated in FIG. 4, regarding parts overlapping with the components illustrated in FIG. 3, detailed explanation will be omitted.

The display 140 is a component that displays images, and it may be implemented as displays in various forms such as a liquid crystal display (LCD), an organic light emitting diodes (OLED) display, a plasma display panel (PDP), etc. Inside the display 140, a driving circuit that may be implemented in forms such as an a-si TFT, a low temperature poly silicon (LTPS) TFT, an organic TFT (OTFT), etc., and a backlight unit, etc. may also be included together. Meanwhile, the display 140 may be implemented as a touch screen combined with a touch sensor, a flexible display, a 3D display, etc.

The user interface 150 may be implemented as buttons, a touch pad, a mouse, and a keyboard, or may be implemented as a touch screen that can perform the display function and a manipulation input function together, etc. In one or more examples, the buttons may be various types of buttons such as a mechanical button, a touch pad, a wheel, etc. formed in any areas such as the front surface part or the side surface part, the rear surface part, etc. of the exterior of the main body of the electronic device 100.

The camera 160 is a component for photographing a still image or a moving image. The camera 160 may photograph a still image on a specific time point, but it may also photograph still images consecutively.

The camera 160 may photograph the actual environment of the front side of the electronic device 100 by photographing the front side of the electronic device 100. The processor 130 may identify the scene type of the image photographed through the camera 160.

The camera 160 includes a lens, a shutter, a diaphragm, a solid imaging element, an analog front end (AFE), and a timing generator (TG). The shutter adjusts the time when a light reflected on a subject enters the camera 160, and the diaphragm adjusts the amount of the light introduced into the lens by mechanically increasing or decreasing the size of the opening through which the light enters. When the light reflected on the subject is accumulated as photo charges, the solid imaging element outputs the phase due to the photo charges as an electric signal. The TG outputs a timing signal for reading out the pixel data of the solid imaging element, and the AFE samples and digitalizes the electric signal output from the solid imaging element.

The microphone 170 is a component for receiving input of a sound and converting it into an audio signal. The microphone 170 may be electrically connected with the processor 130, and receive a sound by control by the processor 130.

For example, the microphone 170 may be formed as an integrated type integrated to the upper side or the front surface direction, the side surface direction, etc. of the electronic device 100. Alternatively, the microphone 170 may be provided on a remote control, etc. separate from the electronic device 100. In this case, the remote control may receive a sound through the microphone 170, and provide the received sound to the electronic device 100.

The microphone 170 may include various components such as a microphone collecting a sound in an analog form, an amp circuit that amplifies the collected sound, an A/D conversion circuit that samples the amplified sound and converts the sound into a digital signal, a filter circuit that removes noise components from the converted digital signal, etc.

Meanwhile, the microphone 170 may also be implemented in the form of a sound sensor, and it can be of any type if it is a component that can collect sounds.

The speaker 180 is a component that outputs not only various types of audio data processed at the processor 130, but also various types of notification sounds or voice messages, etc.

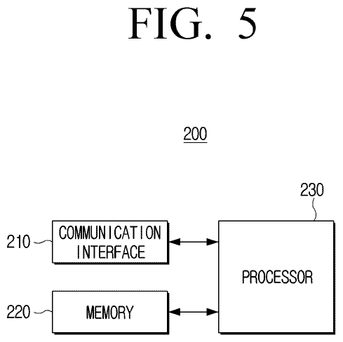

FIG. 5 is a block diagram illustrating a configuration of the server 200 according to one or more embodiments of the disclosure.

According to FIG. 5, the server 200 includes a communication interface 210, memory 220, and a processor 230.

The communication interface 210 is a component performing communication with various types of external devices according to various types of communication methods. For example, the server 200 may perform communication with the electronic device 100 or a user terminal through the communication interface 210.

The communication interface 210 may include a Wi-Fi module, a Bluetooth module, an infrared communication module, and a wireless communication module, etc. Here, each communication module may be implemented in a form of at least one hardware chip.

A Wi-Fi module and a Bluetooth module perform communication by a Wi-Fi method and a Bluetooth method, respectively. In the case of using a Wi-Fi module or a Bluetooth module, various types of connection information such as an SSID and a session key is transmitted and received first, and connection of communication is performed by using the information, and various types of information can be transmitted and received thereafter. An infrared communication module performs communication according to an infrared Data Association (IrDA) technology of transmitting data to a near field wirelessly by using infrared rays between visible rays and millimeter waves.

A wireless communication module may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

Alternatively, the communication interface 210 may include a wired communication interface such as an HDMI, a DP, a Thunderbolt, a USB, an RGB, a D-SUB, a DVI, etc.

Other than the above, the communication interface 210 may include at least one of a local area network (LAN) module, an Ethernet module, or a wired communication module that performs communication by using a pair cable, a coaxial cable, or an optical fiber cable, etc.

The memory 220 may refer to hardware that stores information such as data, etc. in an electric or a magnetic form such that the processor 230, etc. can access the information. For this, the memory 220 may be implemented as at least one hardware among non-volatile memory, volatile memory, flash memory, a hard disc drive (HDD) or a solid state drive (SSD), RAM, ROM, etc.

In the memory 220, at least one instruction necessary for operations of the server 200 or the processor 230 may be stored. Here, an instruction is a code unit instructing the operations of the server 200 or the processor 230, and it may have been drafted in a machine language which is a language that can be understood by a computer. Alternatively, in the memory 220, a plurality of instructions performing specific tasks of the server 200 or the processor 230 may be stored as an instruction set.

In the memory 220, data which is information in bit or byte units that can indicate characters, numbers, images, etc. may be stored. For example, in the memory 220, a plurality of neural network models constituted in a hierarchical tree structure and a plurality of parameters may be stored.

The memory 220 may be accessed by the processor 230, and reading/recording/correction/deletion/update, etc. for an instruction, an instruction set, or data may be performed by the processor 230.

The processor 230 controls the overall operations of the server 200. Specifically, the processor 230 may be connected with each component of the server 200, and control the overall operations of the server 200. For example, the processor 230 may be connected with components such as the communication interface 210, the memory 220, etc., and control the operations of the server 200.

According to one or more embodiments, the processor 230 may be implemented as a digital signal processor (DSP), a microprocessor, and a time controller (TCON). However, the disclosure is not limited thereto, and the processor 230 may include one or more of a central processing unit (CPU), a micro controller unit (MCU), a micro processing unit (MPU), a controller, an application processor (AP) or a communication processor (CP), and an ARM processor, or may be defined by the terms. Also, the processor 230 may be implemented as a system on chip (SoC) having a processing algorithm stored therein or large scale integration (LSI), or in the form of a field programmable gate array (FPGA).

The processor 230 may be implemented as one processor or a plurality of processors. However, hereinafter, operations of the server 200 will be explained with the expression ‘the processor 230,’ for the convenience of explanation.

The processor 230 may receive the scene type of the first frame included in a content from the electronic device 100 through the communication interface 210, and control the communication interface 210 to transmit a first neural network model corresponding to the scene type of the first frame among a plurality of neural network models constituted in a hierarchical tree structure and a first parameter corresponding to the scene type of the first frame among a plurality of parameters to the electronic device 100.

The processor 230 may receive the scene type of a second frame after the first frame from the electronic device 100 through the communication interface 210, and control the communication interface 210 to transmit a second neural network model corresponding to the scene type of the second frame among the plurality of neural network models and a second parameter corresponding to the scene type of the second frame among the plurality of parameters to the electronic device 100. In one or more examples, the second neural network model may be one of a plurality of second neural network models respectively corresponding to a plurality of scene types that can be output from the first neural network model.

The processor 230 may update each of the plurality of neural network models constituted in a hierarchical tree structure. For example, the processor 230 may update each of the plurality of neural network models constituted in the hierarchical tree structure as new scene types are added. In one or more examples, the processor 230 may update one or more of the plurality of neural network models.

Alternatively, the processor 230 may collect training data, and periodically update each of the plurality of neural network models constituted in the hierarchical tree structure. In one or more examples, the training data may include contents received from the electronic device 100.

As described above, the electronic device 100 receives a parameter corresponding to a scene type from the server 200, and performs image processing with the received parameter, and thus, image processing of high performance is possible even with a low specification, and as the electronic device 100 can identify a scene type by receiving one of the plurality of neural network models constituted in the hierarchical tree structure from the server 200, pre-processing is easy.

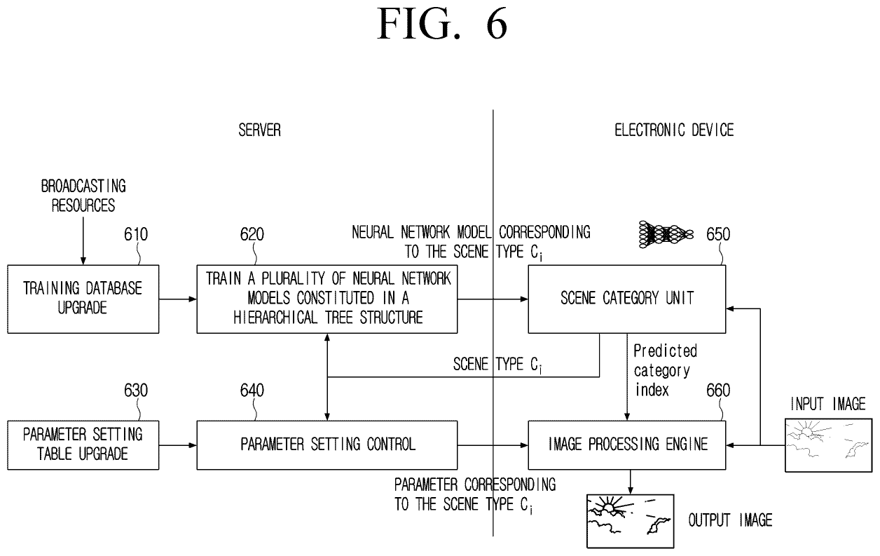

Hereinafter, operations of the electronic device 100 will be described in more detail with reference to FIG. 6 to FIG. 11. In FIG. 6 to FIG. 11, individual embodiments will be explained for the convenience of explanation. However, the individual embodiments in FIG. 6 to FIG. 11 can be implemented in any combined states.

FIG. 6 is a diagram for illustrating operations of the electronic device 100 and the server 200 according to one or more embodiments of the disclosure.

First, as on the left side of FIG. 6, the server 200 may upgrade a training database from broadcasting resources, etc. (610) The server 200 may control a training unit 620 to train the plurality of neural network models constituted in the hierarchical tree structure by using the training database. When a scene type Ci is received from the electronic device 100, the server 200 may provide a neural network model corresponding to the scene type among the plurality of neural network models to the electronic device 100.

Furthermore, the server 200 may upgrade a parameter setting table for image processing according to scene types (630). When a scene type is received from the electronic device 100, the server 200 may provide a parameter corresponding to the scene type among the plurality of parameters to the electronic device 100.

The electronic device 100 may control a scene category control unit to identify a scene type for an input image (650). The electronic device 100 may provide the identified scene type to the server 200, and provide the image to the image processing engine 660. When a neural network model corresponding to the scene type among the plurality of neural network models is received from the server 200, the electronic device 100 may update the neural network model.

When a parameter corresponding to the scene type among the plurality of parameters is received from the server 200, the electronic device 100 may control the image processing engine 660 to perform image processing on the input image by using the parameter.

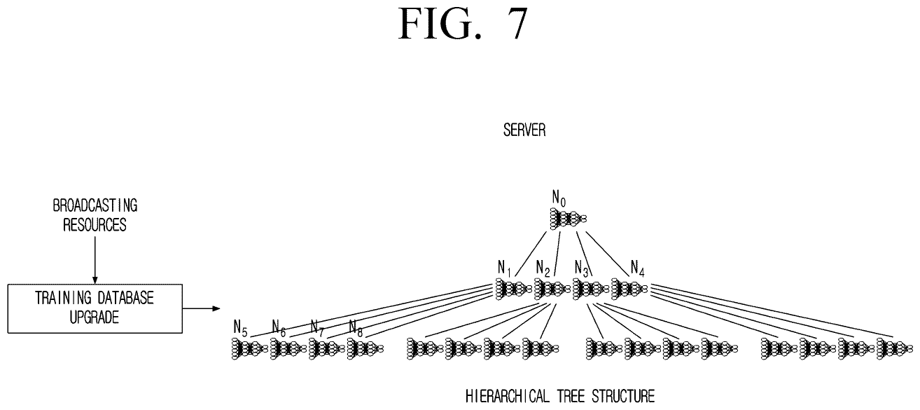

FIG. 7 is a diagram for illustrating a plurality of neural network models constituted in a hierarchical tree structure according to one or more embodiments of the disclosure.

A plurality of neural network models constituted in a hierarchical tree structure may include Ni (i=1 . . . K) neural network models as illustrated in FIG. 7. For example, N0 may be a basic neural network model which is the neural network model of the highest hierarchy (root category) among the plurality of neural network models. Through N0, the neural network models may be classified as a neural network model among N1, N2, N3, N4, and for example, N1 may be a movie/drama type, N2 may be a sport type, N3 may be a game type, and N4 may be a documentary type. For example, in case the electronic device 100 classified a frame 1 by using the N0 neural network model, a frame 2 after the frame 1 may be classified in more detail by using a neural network model among N1, N2, N3, N4. As an example, the neural network models may be classified as a neural network model among N5, N6, N7, N8 through N1, and for instance, N5 may be a black-and-white movie type, N6 may be a black-and-white drama type, N7 may be a color movie type, and N8 may be a color drama type. In this case, if the electronic device 100 classified the frame 2 by using the N1 neural network model, a frame 3 after the frame 2 may be classified in more detail by using a neural network model among N5, N6, N7, N8.

As described above, as the electronic device 100 classifies scene types in a stepwise manner, the electronic device 100 can be implemented with a low specification while identifying scene types in more detail. Furthermore, as the electronic device 100 performs image processing through a parameter corresponding to a detailed scene type, the image processing performance can be improved.

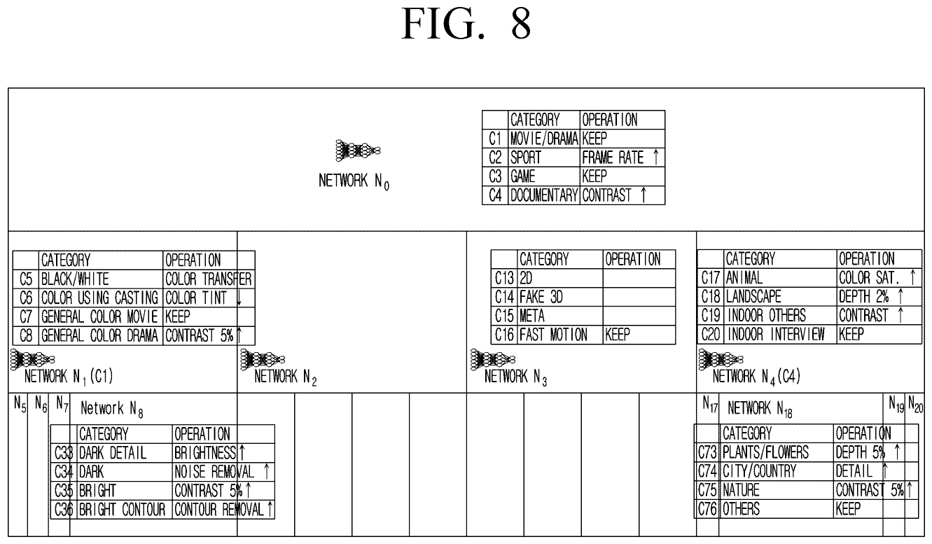

FIG. 8 is a diagram for illustrating in more detail a plurality of neural network models constituted in a hierarchical tree structure according to one or more embodiments of the disclosure.

As illustrated in FIG. 8, the server 200 may store a plurality of neural network models constituted in a hierarchical tree structure.

Here, the server 200 may further store information for controlling the operations of the electronic device 100 based on each scene type. For example, if information that a scene type is a C2 type is received from the electronic device 100, the server 200 may transmit a neural network model corresponding to the C2 type to the electronic device 100, and additionally provide a signal for increasing the frame rate (e.g., parameter).

For example, the server 200 may control the operations of the electronic device 100 according to scene types, and transmit, for example, a control signal such as color adjustment, contrast adjustment, frame rate adjustment, depth adjustment, contour removal, noise removal, luminance adjustment, etc. to the electronic device 100.

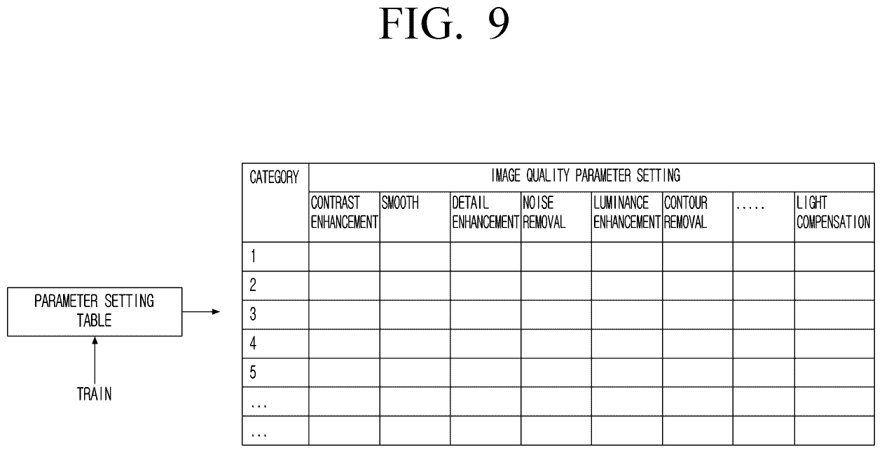

FIG. 9 is a diagram for illustrating information on a plurality of parameters according to one or more embodiments of the disclosure.

As illustrated in FIG. 9, the server 200 may store information on parameters corresponding to each of a plurality of scene types.

For example, the server 200 may store a contrast increase value, a smooth value, a detail improvement value, etc. corresponding to the C1 type.

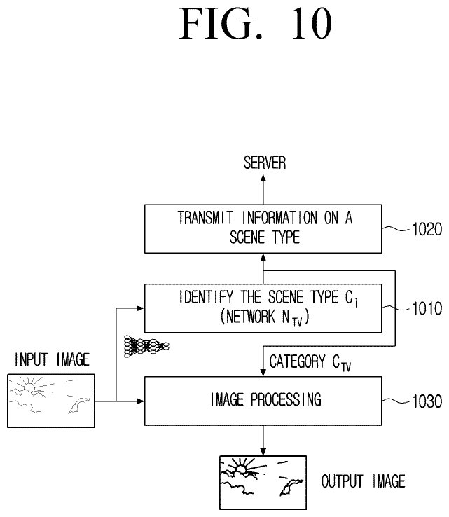

FIG. 10 is a diagram for illustrating an operation after classification of scene types according to one or more embodiments of the disclosure.

First, the electronic device 100 may identify a scene type for an input image (1010). Then, the electronic device 100 may transmit information on the identified scene type to the server 200 as Ci (1020), and perform image processing for the input image by using a parameter corresponding to the identified scene type (1030).

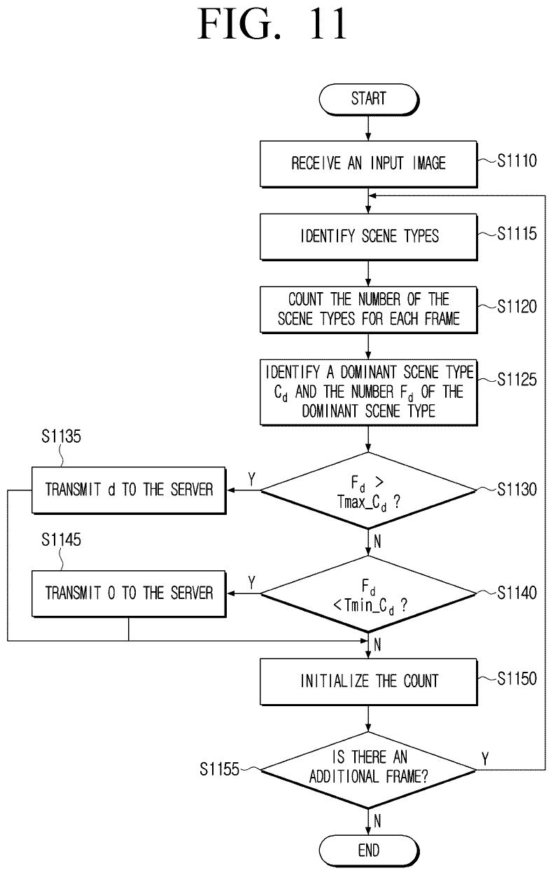

FIG. 11 is a flow chart for illustrating an update of scene types according to one or more embodiments of the disclosure.

First, an image (frames of a content) may be input in the operation S1110, and the electronic device 100 may identify the scene types of the input image in the operation S1115. The electronic device 100 may sequentially identify the scene types of the frames included in the content, and count the number of each scene type in the S1120, and identify a dominant scene type Cd and the number Fd of the dominant scene type in the operation S1125.

The electronic device 100 may compare the number Fd of the dominant scene type and a threshold value Tmax_Cd for changing to a subordinate category of the next level in the operation S1130, and if Fd is bigger than Tmax_Cd, the electronic device 100 may transmit d to the server 200 in the operation S1135. For example, the electronic device 100 gets to request a neural network model corresponding to the subordinate category of the next level.

If Fd is smaller than or equal to Tmax_Cd, the electronic device 100 may compare Fd and a threshold value Tmin_Cd for resetting to the highest category (the basic neural network model) in the operation S1140, and if Fd is smaller than Tmin_Cd, the electronic device 100 may transmit 0 to the server 200 in the operation S1145. For example, the electronic device 100 gets to request the basic neural network model.

If Fd is bigger than or equal to Tmin_Cd, the electronic device 100 may initialize the count in the operation S1150, and if an additional frame is input in the operation S1155-Y, the electronic device 100 may enter the operation S1115, and if an additional frame is not input in the operation S1155-N, the electronic device 100 may end the process.

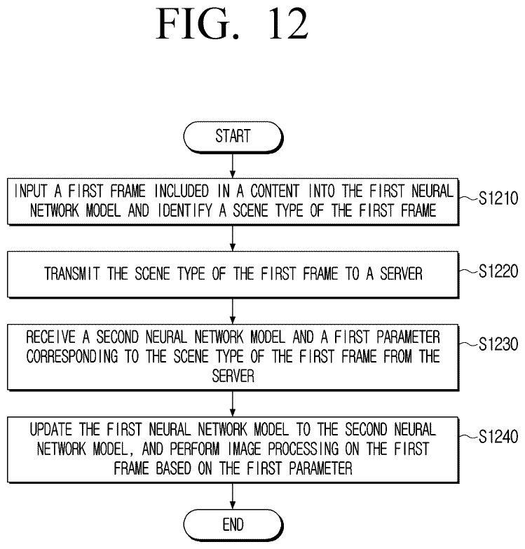

FIG. 12 is a flow chart for illustrating a control method for an electronic device according to one or more embodiments of the disclosure.

First, a first frame included in a content is input into the first neural network model and a scene type of the first frame is identified in the operation S1210. Then, the scene type of the first frame is transmitted to a server in the operation S1220. Then, a second neural network model and a first parameter corresponding to the scene type of the first frame are received from the server in the operation S1230. Then, the first neural network model is updated to the second neural network model, and image processing is performed on the first frame based on the first parameter in the operation S1240. In one or more examples, the second neural network model may be one of a plurality of second neural network models respectively corresponding to a plurality of scene types that can be output from the first neural network model.

Also, the control method may further include the operations of inputting a second frame after the first frame into the second neural network model and identifying a scene type of the second frame, transmitting the scene type of the second frame to the server, receiving a third neural network model and a second parameter corresponding to the scene type of the second frame from the server, and updating the second neural network model to the third neural network model, and performing image processing on the second frame based on the second parameter, and the third neural network model may be one of a plurality of third neural network models respectively corresponding to a plurality of scene types that can be output from the second neural network model.

In one or more examples, in the operation of identifying the scene type of the second frame, a plurality of feature points may be obtained by pre-processing the second frame, and based on the second frame corresponding to the scene type of the first frame on the basis of the plurality of feature points, the second frame may be input into the second neural network model, and the scene type of the second frame may be identified.

Furthermore, in the operation of identifying the scene type of the second frame, based on the second frame not corresponding to the scene type of the first frame on the basis of the plurality of feature points, the second frame may be input into the basic neural network model and the scene type of the second frame may be identified, and the basic neural network model may be a neural network model of the highest hierarchy among a plurality of neural network models stored in a hierarchical tree structure in the server.

In addition, the control method may further include the operation of receiving a user input regarding an operation mode, and in the operation of performing image processing on the second frame, based on the operation mode being a first mode, the second neural network model may be updated to the third neural network model, and based on the operation mode being a second mode, the second neural network model may not be updated to the third neural network model.

Meanwhile, in the operation S1240 of performing image processing on the first frame, image processing may be performed on the frames included in the content by using image processing engines corresponding to the scene types of the frames included in the content among the plurality of image processing engines.

Furthermore, in the operation S1210 of identifying the scene types, the scene types of the frames included in the content may be updated by a predetermined interval.

In one or more examples, the control method may further include the operation of, based on the number of times of identifying scene types through one neural network model being greater than or equal to a predetermined number of times, identifying scene types by using the basic neural network model, and the basic neural network model may be a neural network model of the highest hierarchy among a plurality of neural network models stored in a hierarchical tree structure in the server.

In one or more examples, the control method may further include the operation of displaying the first frame that went through image processing.

According to the various embodiments of the disclosure as described above, an electronic device receives a parameter corresponding to a scene type from a server, and performs image processing with the received parameter, and thus image processing of high performance is possible even with a low specification.

In one or more examples, the server stores a plurality of neural network models constituted in a hierarchical tree structure, and the electronic device can identify a scene type by receiving one of the plurality of neural network models from the server, and thus pre-processing is easy.

In addition, the electronic device can identify various scene types, and as neural network models are stored in the server, there is an effect that upgrade of the neural network models is easy.

In one or more examples, according to one or more embodiments of the disclosure, the aforementioned various embodiments may be implemented as software including instructions stored in machine-readable storage media, which can be read by machines (e.g., computers). The machines refer to devices that call instructions stored in a storage medium, and can operate according to the called instructions, and the devices may include an electronic device according to the aforementioned embodiments (e.g., an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

In one or more examples, according to one or more embodiments of the disclosure, a method according to the aforementioned various embodiments may be provided while being included in a computer program product. A computer program product refers to a product, and it can be traded between a seller and a buyer. A computer program product can be distributed on-line in the form of a storage medium that is readable by machines (e.g., compact disc read only memory (CD-ROM)), or through an application store (e.g., Play Store™). In the case of on-line distribution, at least a portion of a computer program product may be stored in a storage medium such as the server of the manufacturer, the server of the application store, and the memory of the relay server at least temporarily, or may be generated temporarily.

In addition, according to one or more embodiments of the disclosure, the aforementioned various embodiments may be implemented in a recording medium that is readable by a computer or a device similar thereto, by using software, hardware or a combination thereof. In some cases, the embodiments described in this specification may be implemented as a processor itself. According to implementation by software, the embodiments such as procedures and functions described in this specification may be implemented as separate software. Each software may perform one or more functions and operations described in this specification.

In one or more examples, computer instructions for performing processing operations of a device according to the aforementioned various embodiments may be stored in a non-transitory computer-readable medium. Computer instructions stored in such a non-transitory computer-readable medium make the processing operations at a device according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory. As specific examples of a non-transitory computer-readable medium, there may be a CD, a DVD, a hard disc, a blue-ray disc, a USB, a memory card, ROM and the like.

In one or more examples, each of the components (e.g., a module or a program) according to the aforementioned various embodiments may consist of a singular object or a plurality of objects. In addition, among the aforementioned corresponding sub components, some sub components may be omitted, or other sub components may be further included in the various embodiments. Alternatively or additionally, some components (e.g., a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

In one or examples, while preferred embodiments of the disclosure have been shown and described, the disclosure is not limited to the aforementioned specific embodiments, and it is apparent that various modifications may be made by those having ordinary knowledge in the technical field to which the disclosure belongs, without departing from the gist of the disclosure as claimed by the appended claims. Further, it is intended that such modifications are not to be interpreted independently from the technical idea or prospect of the disclosure.

1. An electronic device comprising:
memory storing one or more instructions and a first neural network model;
a communication interface; and
at least one processor operatively coupled with the memory and the communication interface,
wherein the one or more instructions, when executed by the at least one processor, causes the electronic device to:
identify a scene type of a first frame included in a content by inputting the first frame into the first neural network model,
control the communication interface to transmit the scene type of the first frame to a server,
receive, from the server through the communication interface in response to the transmitted scene type of the first frame, a second neural network model and a first parameter corresponding to the scene type of the first frame,
replace the first neural network model with the second neural network model, and perform image processing on the first frame based on the first parameter, and
wherein the second neural network model is one of a plurality of second neural network models respectively corresponding to a plurality of scene types that can be output from the first neural network model.

2. The electronic device of claim 1, wherein the one or more instructions, when executed by the at least one processor, further cause the electronic device to:
identify a scene type of a second frame after the first frame by inputting the second frame into the second neural network model,
control the communication interface to transmit the scene type of the second frame to the server,
receive, from the server through the communication interface in response to the transmitted scene type of the second frame, a third neural network model and a second parameter corresponding to the scene type of the second frame from the server through the communication interface,
replace the second neural network model with the third neural network model, and perform image processing on the second frame based on the second parameter, and
wherein the third neural network model is one of a plurality of third neural network models respectively corresponding to a plurality of scene types that can be output from the second neural network model.

3. The electronic device of claim 2, wherein the one or more instructions, when executed by the at least one processor, further cause the electronic device to:
obtain a plurality of feature points by pre-processing the second frame, and
based on the second frame corresponding to the scene type of the first frame on the basis of the plurality of feature points, input the second frame into the second neural network model to identify the scene type of the second frame.

4. The electronic device of claim 3, wherein the memory further stores a basic neural network model, and
wherein the one or more instructions, when executed by the at least one processor, further cause the electronic device to:
based on the second frame not corresponding to the scene type of the first frame on the basis of the plurality of feature points, identify the scene type of the second frame by inputting the second frame into the basic neural network model, and
wherein the basic neural network model is a neural network model of a highest hierarchy among a plurality of neural network models stored in a hierarchical tree structure in the server.

5. The electronic device of claim 2, further comprising:
a user interface,
wherein the one or more instructions, when executed by the at least one processor, further cause the electronic device to:
receive a user input regarding an operation mode through the user interface, and
based on determining the operation mode is a first mode, update the second neural network model to the third neural network model, and based on determining the operation mode is a second mode, not update the second neural network model to the third neural network model.

6. The electronic device of claim 1,
wherein the memory further stores a plurality of image processing engines, and
wherein the one or more instructions, when executed by the at least one processor, further cause the electronic device to:
perform image processing on the frames included in the content by using one or more image processing engines from the plurality of image processing engines corresponding to the scene types of the frames included in the content.

7. The electronic device of claim 1, wherein the one or more instructions, when executed by the at least one processor, further causes the electronic device to:
update the scene types of the frames included in the content by a predetermined interval.

8. The electronic device of claim 1,
wherein the memory further stores a basic neural network model, and
wherein the one or more instructions, when executed by the at least one processor, further cause the electronic device to:
based on a number of times of identifying scene types through one neural network model being greater than or equal to a predetermined number of times, identify scene types by using the basic neural network model, and
wherein the basic neural network model is a neural network model of a highest hierarchy among a plurality of neural network models stored in a hierarchical tree structure in the server.

9. The electronic device of claim 1, further comprising:
a display, and
wherein the one or more instructions, when executed by the at least one processor, further causes the electronic device to:
control the display to display the first frame that went through image processing.

10. A control method for an electronic device, the method comprising:
identifying a scene type of a first frame included in a content by inputting the first frame into the first neural network model;
transmitting the scene type of the first frame to a server;
receiving, from the server in response to the transmitted scene type of the first frame, a second neural network model and a first parameter corresponding to the scene type of the first frame; and
replacing the first neural network model with the second neural network model, and performing image processing on the first frame based on the first parameter,
wherein the second neural network model is one of a plurality of second neural network models respectively corresponding to a plurality of scene types that can be output from the first neural network model.

11. The control method of claim 10, further comprising:
identifying a scene type of a second frame after the first frame by inputting the second frame into the second neural network model;
transmitting the scene type of the second frame to the server;
receiving, from the server in response to transmitting the scene type of the second frame, a third neural network model and a second parameter corresponding to the scene type of the second frame; and
replacing the second neural network model with the third neural network model, and performing image processing on the second frame based on the second parameter,
wherein the third neural network model is one of a plurality of third neural network models respectively corresponding to a plurality of scene types that can be output from the second neural network model.

12. The control method of claim 11,
wherein the identifying the scene type of the second frame comprises:
obtaining a plurality of feature points by pre-processing the second frame; and
based on the second frame corresponding to the scene type of the first frame on the basis of the plurality of feature points, inputting the second frame into the second neural network model to identify the scene type of the second frame.

13. The control method of claim 12,
wherein the identifying the scene type of the second frame comprises:
based on the second frame not corresponding to the scene type of the first frame on the basis of the plurality of feature points, identifying the scene type of the second frame by inputting the second frame into the basic neural network model, and
wherein the basic neural network model is a neural network model of the highest hierarchy among a plurality of neural network models stored in a hierarchical tree structure in the server.

14. The control method of claim 11, further comprising:
receiving a user input regarding an operation mode,
wherein the performing image processing on the second frame comprises:
based on determining the operation mode is a first mode, updating the second neural network model to the third neural network model, and based on determining the operation mode is a second mode, not updating the second neural network model to the third neural network model.

15. The control method of claim 10,
wherein the performing image processing on the first frame comprises:
performing image processing on the frames included in the content by using one or more image processing engines among a plurality of image processing engines corresponding to the scene types of the frames included in the content.

16. A non-transitory computer readable medium, having instructions stored therein, which when executed by a processor in an electronic device, cause the electronic device to perform a method comprising:
identifying a scene type of a first frame included in a content by inputting the first frame into the first neural network model;
transmitting the scene type of the first frame to a server;
receiving, from the server in response to the transmitted scene type of the first frame, a second neural network model and a first parameter corresponding to the scene type of the first frame; and
replacing the first neural network model with the second neural network model, and performing image processing on the first frame based on the first parameter,
wherein the second neural network model is one of a plurality of second neural network models respectively corresponding to a plurality of scene types that can be output from the first neural network model.

17. The non-transitory computer readable medium according to claim 16, wherein the method further comprises:
identifying a scene type of a second frame after the first frame by inputting the second frame into the second neural network model;
transmitting the scene type of the second frame to the server;
receiving, from the server in response to transmitting the scene type of the second frame, a third neural network model and a second parameter corresponding to the scene type of the second frame; and
replacing the second neural network model with the third neural network model, and performing image processing on the second frame based on the second parameter,
wherein the third neural network model is one of a plurality of third neural network models respectively corresponding to a plurality of scene types that can be output from the second neural network model.

18. The non-transitory computer readable medium according to claim 16,
wherein the identifying the scene type of the second frame comprises:
obtaining a plurality of feature points by pre-processing the second frame; and
based on the second frame corresponding to the scene type of the first frame on the basis of the plurality of feature points, inputting the second frame into the second neural network model to identify the scene type of the second frame.

19. The non-transitory computer readable medium according to claim 18,
wherein the identifying the scene type of the second frame comprises:
based on the second frame not corresponding to the scene type of the first frame on the basis of the plurality of feature points, identifying the scene type of the second frame by inputting the second frame into the basic neural network model, and
wherein the basic neural network model is a neural network model of the highest hierarchy among a plurality of neural network models stored in a hierarchical tree structure in the server.

20. The non-transitory computer readable medium according to claim 16, wherein the method further comprises:
receiving a user input regarding an operation mode,
wherein the performing image processing on the second frame comprises:
based on determining the operation mode is a first mode, updating the second neural network model to the third neural network model, and based on determining the operation mode is a second mode, not updating the second neural network model to the third neural network model.
